(19) United States
(12) Patent Application Publication
(10) Pub. No.: US 2013/0208313 A1
(43) Pub. Date: Aug. 15, 2013

(54) IMAGE PROCESSING APPARATUS, METHOD FOR CONTROLLING IMAGE PROCESSING APPARATUS, AND PROGRAM

(71) Applicant: Canon Kabushiki Kaisha, (US)

(72) Inventor: Ryo Maeda, Yokohama-shi (JP)

(73) Assignee: CANON KABUSHIKI KAISHA, Tokyo (JP)

(21) Appl. No.: 13/760,913

(22) Filed: Feb. 6, 2013

(30) Foreign Application Priority Data
Feb. 9, 2012 (JP) 2012-026159

(51) Int. Cl. G06F 3/0485

(52) U.S. Cl. CPC G06F 3/0485
USPC 358/1.15; 715/784

(57) ABSTRACT

An image processing apparatus displays image data including a plurality of pages, and scroll-displays the image data in response to a predetermined operation by a user to the displayed image data. In this case, the image processing apparatus obtains a feature amount representing a feature of each image among the plurality of pages, and in a case where a predetermined page having a feature amount satisfying a predetermined condition is scroll-displayed, stops the scroll display.

### BACKGROUND

1. Field of the Invention

Aspects of the present invention relate to an image processing apparatus, a method for controlling an image processing apparatus, and a program.

2. Description of the Related Art

In recent years, an information processing apparatus including a touch panel has been generally utilized. When the information processing apparatus is utilized, a flick operation is performed on a screen to scroll an arbitrary image displayed on the screen. For example, the touch panel is provided in a display unit included in a copying machine, and an image after scanning processing is preview-displayed before printing. A user performs the flick operation, and thereby the user can scroll and confirm each page.

Since the scroll display of the screen by the flick operation provides a user's intuitive operation and smoothly displayed scroll, the scroll display is extremely convenient to the user. On the other hand, the scroll display smoothly performed at high speed easily causes a problem that the user overlooks an image to be confirmed.

Japanese Patent Application Laid-Open No. 2010-152777 discusses a technique as a solution to the problem in which a level of importance for every content is calculated based on user information in the list display of a plurality of contents and a scroll speed is changed according to the level of importance for every calculated content. That is, the scroll speed is reduced while the content having a high level of importance is scroll-displayed.

In the conventional technique, surely, the content calculated to have a high level of importance is hardly overlooked during the scroll display. However, in the conventional technique, processing for calculating the level of importance of each content is complicated. Nevertheless, the content calculated to have a high level of importance does not necessarily conform to the content that the user desires to confirm.

For example, when the image after scanning processing is preview-displayed before printing in the copying machine, and the user confirms the image of each page, the change in a feature amount between pages is often more important than the level of importance of each page. Specifically, when only a page in which top and bottom are inverted is mixed in a plurality of pages, it is important that the page is easily found by preview. The page is a page in which the feature amount is changed as compared with the other page.

However, the conventional technique specifies the content having a high level of importance according to an absolute reference to each content. The conventional technique cannot specify the content according to a relative reference in comparison with the other content.

### SUMMARY OF THE INVENTION

Aspects of the present intention relate to further enhancing convenience of a user confirming a content of scroll-displayed image data compared with the conventional one.

According to one aspect of the present invention, an image processing apparatus includes a display control unit to display image data including a plurality of pages; a scroll display unit to scroll-display the image data in response to a predetermined operation by a user to the image data displayed by the display control unit, an obtaining unit to obtain a feature amount representing a feature of each image among the plurality of pages, and a control unit, in a case where a predetermined page having a feature amount satisfying a predetermined condition is displayed by the scroll display unit, to stop the scroll display.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a hardware block diagram of an MFP in the present exemplary embodiment.

FIG. 2 illustrates a screen example displayed on a display of an MFP in the present exemplary embodiment.

FIG. 3 illustrates an operation example of a preview image in the present exemplary embodiment.

FIG. 4 illustrates an operation example of a preview image in the present exemplary embodiment.

FIG. 5 illustrates an operation example of a preview image in the present exemplary embodiment.

FIG. 6 is a flow chart illustrating processing of an MFP in the present exemplary embodiment.

FIG. 7 is a flow chart illustrating processing of an MFP in the present exemplary embodiment.

FIG. 8 illustrates an example of image data preview-displayed in the present exemplary embodiment.

FIG. 9 illustrates an example of image data preview-displayed in the present exemplary embodiment.

FIG. 10 illustrates an example of image data preview-displayed in the present exemplary embodiment.

FIG. 11 illustrates an example of image data preview-displayed in the present exemplary embodiment.

FIG. 12 is a flow chart illustrating processing of an MFP in the present exemplary embodiment.

FIGS. 13A and 13B illustrate an example of image data preview-displayed in the present exemplary embodiment.

FIGS. 14A and 14B illustrate an example of image data preview-displayed in the present exemplary embodiment.

### DESCRIPTION OF THE EMBODIMENTS

Various exemplary embodiments, features, and aspects of the invention will be described in detail below with reference to the drawings.

It should be noted that the following exemplary embodiments do not limit the present invention as recited in the appended claims, and that all of combinations of features described in the exemplary embodiments are not certainly indispensable as solutions in the present invention.

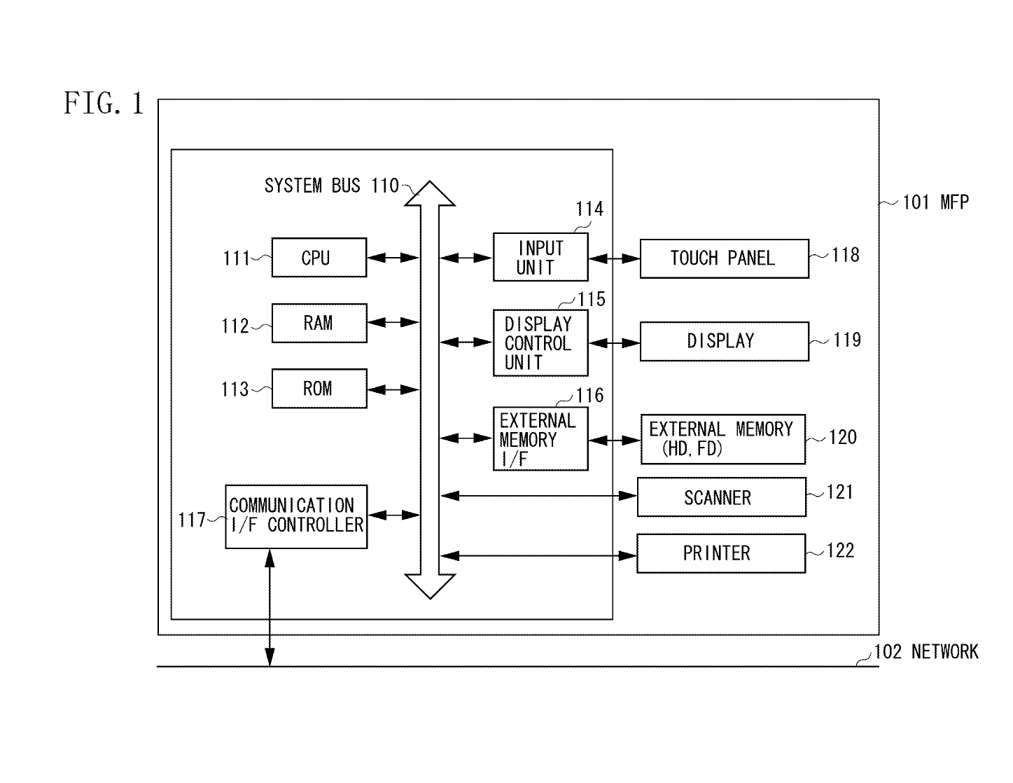

A first exemplary embodiment will be described. FIG. 1 illustrates a hardware configuration of a multi function peripheral (MFP) which is an example of an apparatus configured to conduct the present invention.

In FIG. 1, a central processing unit (CPU) 111, a random access memory (RAM) 112, a read only memory (ROM) 113, an input unit 114, a display control unit 115, an external memory I/F 116, and a communication I/F controller 117 are connected to a systembus 110. A touch panel 118, a display 119, and an external memory 120 are connected. The units connected to the system bus 110 are configured to exchange data to each other via the system bus 110.

The ROM 113 is a nonvolatile memory, and respectively stores image data, the other data, and various programs for operating the CPU 111 in predetermined areas. The RAM 112 is a volatile memory, and is used as a temporary storage area such as a main memory or a work area of the CPU 111. The CPU 111 controls the units of an MFP 101 using the RAM 112 as a work memory according to the programs stored in the ROM 113, for example. The programs for operating the CPU 101 may be previously stored in the external memory (hard disk) 120 without being limited to those stored in the ROM 113.

The input unit 114 receives a user operation, generates a control signal according to the operation, and supplies the control signal to the CPU 111. For example, the input unit 114 has a character information input device (not illustrated) such as a keyboard and a pointing device such as a mouse (not illustrated) or the touch panel 118 as an input device configured to receive the user operation. The touch panel 118 is an input device configured to output coordinate information according to a position brought into contact with an input unit configured in a planar manner, for example. The CPU 111 controls the units of the MFP 101 according to the programs based on the control signal generated and supplied by the input unit 114 according to the user operation performed to the input device. This can cause the MFP 101 to perform an operation according to the user operation.

The display control unit 115 outputs a display signal for displaying to the display 119 an image. For example, the CPU 111 generates a display control signal according to the programs, and supplies the display control signal to the display control unit 115. The display control unit 115 generates a display signal based on the display control signal, and outputs the display signal to the display 119. For example, the display control unit 115 displays a graphical user interface (GUI) screen configuring a GUI on the display 119 based on the display control signal generated by the CPU 111.

The touch panel 118 is integrated with the display 119. For example, the touch panel 118 has such a light transmittance which never impedes display on the display 119. The touch panel 118 is attached on an upper layer of the display screen of the display 119. Input coordinates on the touch panel 118 are associated with display coordinates on the display 119. This allows constructing a GUI which makes a user feel as if the user can directly operate the screen displayed on the display 119.

The external memory 120 such as a hard disk, a floppy (registered trademark) disk, CD, DVD, or a memory card can be attached to the external memory I/F 116, for example. Data from the attached external memory 120 is read based on the control of the CPU 111, and data is written in the external memory 120. The communication I/F controller 117 performs communication with various networks 102 such as a local area network (LAN), the Internet, wire transmission, and wireless transmission based on the control of the CPU 111. Various apparatuses such as a personal computer (PC), the other MFP, a printer, and a server are connected to the network 102, being communicable with the MFP 101.

A scanner 121 reads a document, and generates the image data. A printer 122 executes a print job based on user's instruction input via the input unit 114 and a command input from an external device via the communication I/F controller 117.

The CPU 111 can detect the following operations and states on the touch panel 118, for example. Touching the touch panel 118 by a finger or pen (hereinafter, referred to as “touch-down”). Keeping the finger or pen in contact with the touch panel 118 (hereinafter, referred to as “touch-on”). Moving the finger or pen keeping in contact with the touch panel 118 (hereinafter, referred to as “move”). Moving the finger or pen off the touch panel 118 (hereinafter, referred to as “touch-up”). Nothing in contact with the touch panel 118 (hereinafter, referred to as “touch-off”).

The CPU 111 is notified, via the system bus 110, of the above operations or position coordinates where the finger or pen touches the touch panel 118. The CPU 111 determines the operation performed on the touch panel 118 based on the notified information. As for move, the moving direction of the finger or pen which moves on the touch panel 118 can be also determined for each of vertical components and horizontal components on the touch panel 118 based on the change in the position coordinates. A stroke is drawn by performing touch-down, move for a predetermined distance, and touch-up on the touch panel 118. An operation for quickly drawing a stroke is referred to as flick. The flick is an operation for quickly moving a finger on the touch panel 118 for a certain distance while keeping the finger and the touch panel 118 in contact with each other and then directly moving the finger off. In other words, the flick is an operation for quickly tracing the touch panel 118 like a flip.

Upon detecting move for a predetermined distance or greater at a predetermined speed or greater and then direct touch-up, the CPU 111 can determine that the flick is performed. Upon detecting move for a predetermined distance or greater and then touch-on is kept detected, the CPU 111 determines that drag is performed. The touch panel 118 may be of any of various types such as a resistive film type, capacitance type, surface acoustic type, infrared type, electromagnetic induction type, image recognition type, and photosensor type.

Next, a preview function included in the MFP 101 will be described. In the present exemplary embodiment, the preview function is a function for displaying on the display 119 the image data stored in the RAM 112 or the external memory 120. The CPU 111 generates image data of a format suitable for being displayed on the display 119, from the image data. Hereinafter, the image data of the format suitable for being displayed on the display 119 is referred to as a preview image. The stored image data of the external memory 120 may include a plurality of pages. In that case, the preview image is generated for every page.

The MFP 101 can store the image data in the RAM 112 or the external memory 120 according to one or more methods. One method stores image data generated from a document read by the scanner 121. Alternatively, another method stores image data received from the external device such as a PC connected on the network 102 via the communication I/F controller 117. Alternatively, still another method stores image data received from a portable storage medium (a USB memory, a memory card) attached to the external memory I/F 116. In addition, image data may be stored in the external memory 120 by the other method.

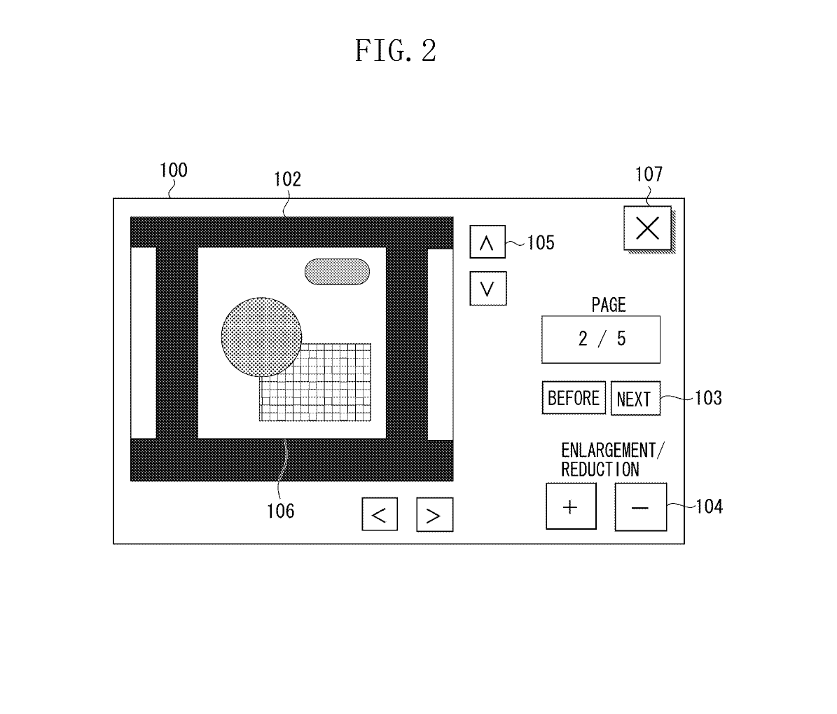

FIG. 2 illustrates an example of a screen illustrating a state where the preview image is displayed on the display 119 of the MFP 101. A preview screen 100 in FIG. 2 is a screen for displaying the preview image. The preview screen 100 includes a preview display area 102, a page scroll button 103, an enlargement/reduction button 104, a display area moving button 105, and a close button 107. The preview display area 102 is a display area for displaying a preview image 106. Further, a plurality of preview images (for a plurality of pages) may be displayed at once.

In FIG. 2, one preview image 106 is displayed as an example on the preview display area 102. However, the preview images of the previous and next pages are partially displayed on both the ends of the preview display area 102 to illustrate that the next page and the previous page exist. The page scroll button 103 is a button which can be pushed when the preview image of the next page or the previous page exists. The user pushes the button, and thereby the preview image 106 displayed on the preview display area 102 can be changed to a page in a direction illustrated by the button pushed by the user.

The enlargement/reduction button 104 is a button for changing the display magnification of the preview image 106 displayed on the preview display area 102. The display magnification is divided into a plurality of stages, and the display magnification can be changed to arbitrary display magnification by user's instruction. The display area moving button 105 is a button for changing the display position of the preview image 106 displayed on the preview display area 102. When the display magnification is enlarged by the enlargement/reduction button 104, only a part of the preview image 106 may be displayed on the preview display area 102. In that case, the arbitrary position of the preview image 106 can be displayed by the display area moving button 105. The close button 107 is a button for closing the preview screen 100 to cause the screen transit to another screen, or ending the preview function.

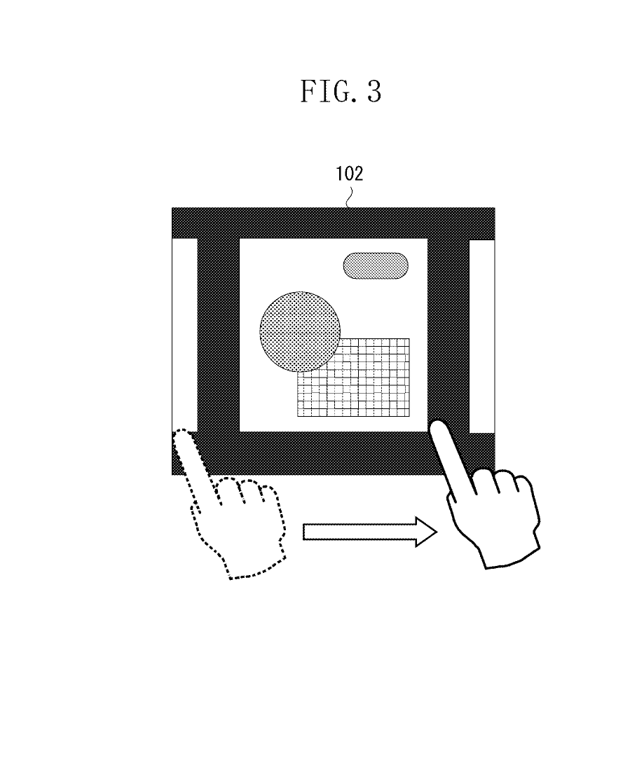

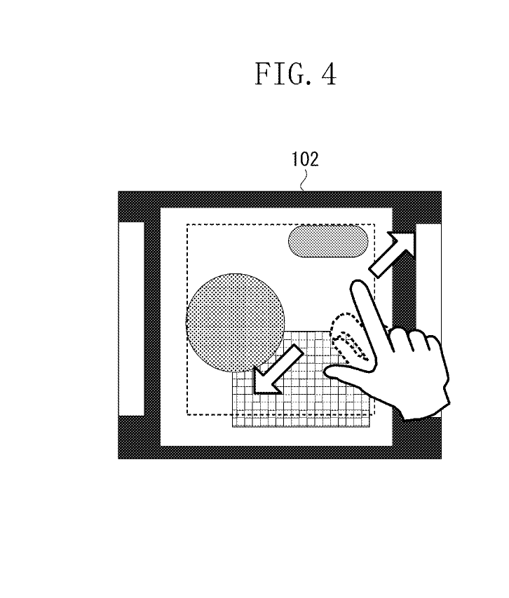

FIGS. 3 and 4 illustrate how display operation is performed on the preview image 106 displayed on the preview display area 102 by a gesture operation using the touch panel. The MFP 101 can operate the display of the preview image 106 according to the gesture operation in place of the page scroll button 103, the enlargement/reduction button 104, and the display area moving button 105. Examples of the gesture operation include, other than the flick or the drag, pinch-out which is an operation for expanding the distance of two or more points from a state (touch-down) where the points on the touch panel are touched, and pinch-out which is an operation for conversely narrowing the distance. The other operation may be employed as the gesture operation.

It may be changed whether to receive the gesture operation as setting for deciding the operation of the apparatus of the MFP 101. In the case of setting for receiving the gesture operation, the page scroll button 103, the enlargement/reduction button 104, and the display area moving button 105 may be non-displayed.

FIG. 3 illustrates how a page to be preview-displayed is changed using the flick operation in place of the page scroll button 103. As illustrated in FIG. 3, the preview image of the previous page (page hidden on a left side) is displayed at a center according to scroll to a right direction by the flick operation performed to the right direction. The preview image of the next page (page hidden on a right side) is displayed at a center according to scroll to a left direction by the flick operation performed to the left direction.

FIG. 4 illustrates how the display magnification of the preview image 106 is changed using a pinch-in operation and a pinch-out operation in place of the enlargement/reduction button 104. When the pinch-out is used, the display magnification becomes high, so that the preview image 106 is displayed being enlarged. When the pinch-in is conversely used, the display magnification becomes lower, so that the preview image 106 is displayed being reduced.

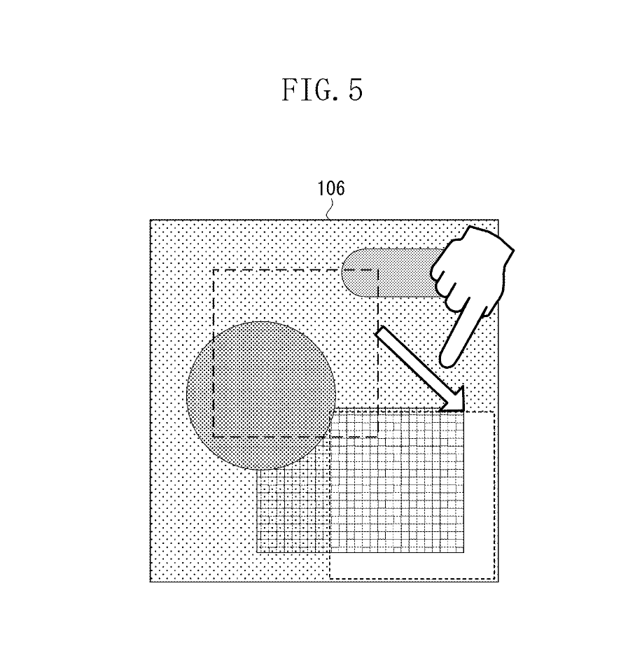

FIG. 5 illustrates how the display position is changed using a drag operation in place of the display area moving button 105. In the example of FIG. 5, the display position of the preview image 106 is changed by dragging the preview image 106 from an upper left direction to a lower right direction.

A correspondence relationship between the gesture operation and display control performed by the gesture operation may be except those exemplified in FIGS. 3 to 5. For example, the display magnification may be changed by the touch-down; the display position may be changed by the flick; page scroll may be performed by the pinch-in or the pinch-out; or the preview screen 100 may be closed by double-tap (operation for performing the touch-down twice in a row).

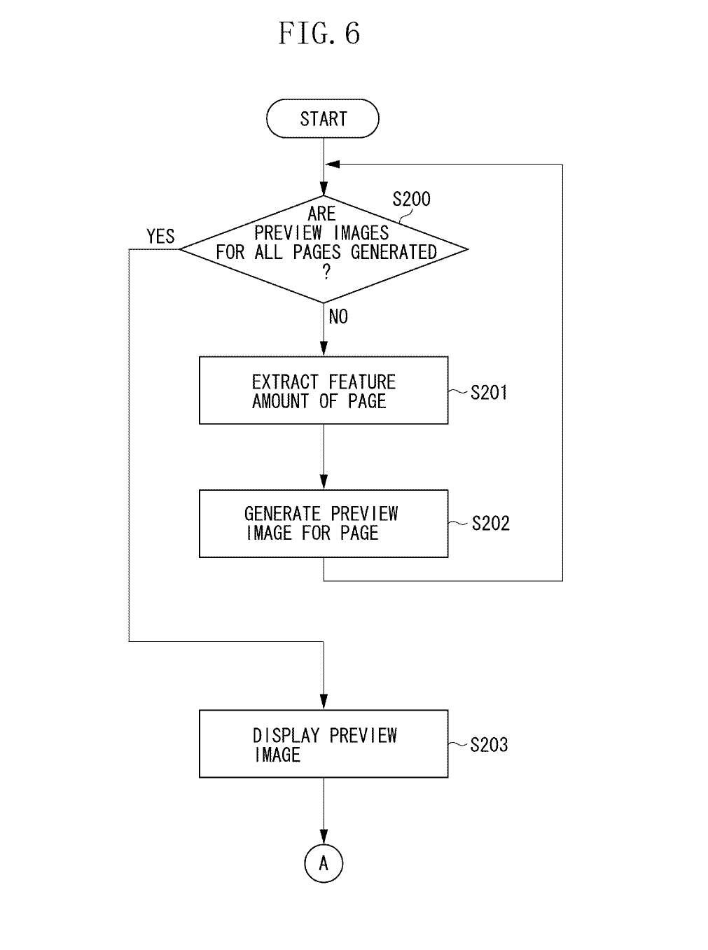

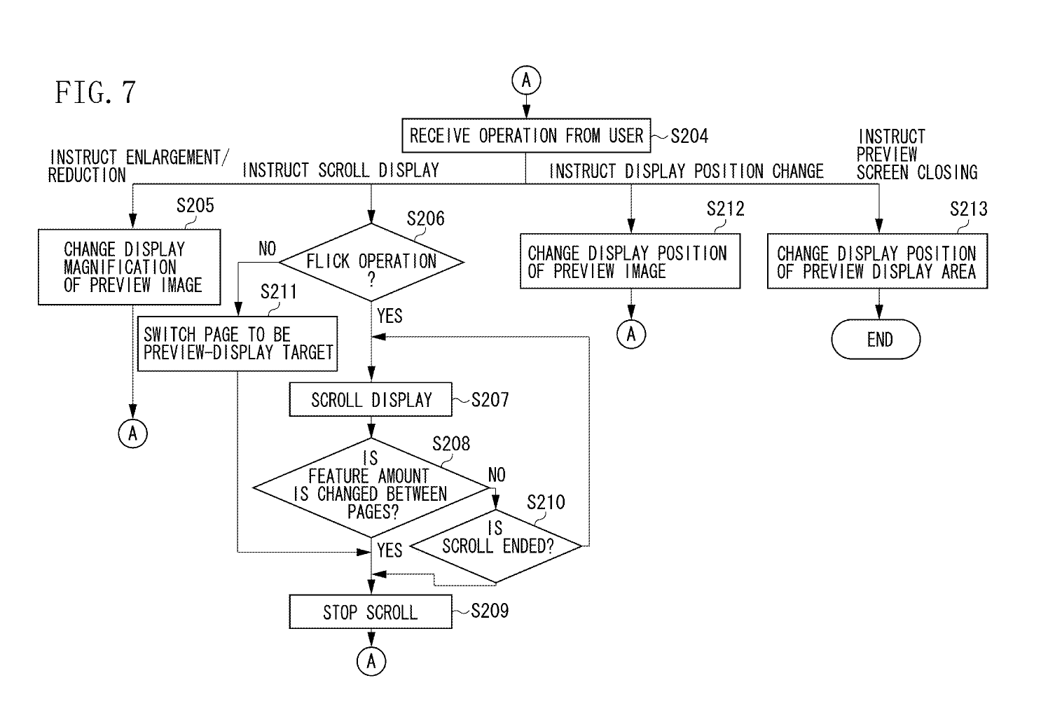

Next, when the display of the preview image is instructed by the user, processing executed in the MFP 101 will be described using a flow chart of FIGS. 6 and 7. The CPU 111 of the MFP 101 executes the programs to process steps of the flow chart illustrated in FIGS. 6 and 7. The programs are stored in a memory such as the ROM 113 or the external memory 120. The programs are developed in the RAM 112 and executed.

When the display of the preview image is instructed by the user, the MFP 101 starts the flow chart. First, in step S200, the CPU 111 determines whether the preview image is generated for all pages of the image data to be preview-display target. When the CPU 111 determines that the preview image is not generated (NO in step S200), the processing proceeds to step S201. In step S201, the CPU 111 analyzes an image of one page included in the image data, and extracts a feature amount of the image of the page. The feature amount is information representing the feature of the image. Examples thereof include information about whether a color image or a monochrome image, size information of an image, information of an orientation representing the top and bottom of image data, and information representing that an image is obliquely inclined. The other examples thereof include a data amount of an image, an orientation, a date, and an image characteristic.

Examples of the image characteristic include a tint of an image, a density of a character, and a rate of the character and a photograph. When the preview image before print processing is executed is displayed, and print setting can be changed for every page, a setting value of print setting of each page may be further used as the feature amount. Examples thereof include information such as information of an output paper size, setting information of reduced layout (2in1 layout and 4in1 layout), and existence or non-existence of both side print setting. In step S201, the CPU 111 extracts and stores the feature amount for an image of a certain page.

Then, in step S202, the CPU 111 generates the preview image from the image of the page from which the feature amount is extracted. Herein, in the case of the preview display before the print processing is executed, the preview image in which the print setting input by the user in advance is reflected may be generated. For example, the preview image illustrating a state where the reduced layout (2in1 layout and 4in1 layout), both side setting, and staple processing are performed is displayed, and thereby the user can confirm a state of the same image as that of an output result.

After the CPU 111 ends the processing of step S202, the processing returns to step S200. The CPU 111 repeats the processings for the next page until the CPU 111 ends the processings of steps S201 and S202 for all the pages. Until the CPU 111 generates the preview images for all the pages, the CPU 111 does not display the preview images in the flow chart. However, when the CPU 111 can generate the preview image for the page to be first displayed, the CPU 111 may start the display of the preview image. In that case, the CPU 111 executes the processing of step S201 or step S202 in parallel to the process ing of step S203.

In step S203, the CPU 111 displays the preview image on the display 119 using the preview image generated in step S202. When the CPU 111 preview-displays the image data including a plurality of pages, the CPU 111 usually preview-displays the image data of the first page at first.

Then, in step S204, the CPU 111 receives an operation by the user. When the operation received in step S204 is an operation for instructing enlargement or reduction of the preview image, the processing proceeds to step S205. The operation is any of the push of the enlargement/reduction button 104 and the pinch-in or pinch-out operation to the preview image. In step S205, the CPU 111 changes the display magnification of the preview image. Then, the processing returns to step S204.

When the operation received in step S204 is the scroll of the preview image, the processing proceeds to step S206. The operation is any of the push of the page scroll button 103 and the flick operation to the preview image. In step S206, the CPU 111 determines whether the received operation is the flick operation. When the CPU 111 determines the operation is not the flick operation (i.e., when the CPU 111 determines that the operation is the push of the page scroll button 103) (NO in step S206), the processing proceeds to step S211. In step S211, the CPU 111 switches the preview-displayed page to the next page (or the previous page), and displays the next page (or the previous page). When the CPU 111 determines that the operation is the flick operation in step S206 (YES in step S206), the processing proceeds to step S207. In step S207, the CPU 111 performs scroll display so that the page is scrolled according to the direction of the flick operation.

In step S208, the CPU 111 compares a feature amount of a page in which the preview image is displayed at present with a feature amount of a page to be displayed next in displaying the next page on the display 119 according to the scroll display. Since the CPU 111 analyzes and holds the feature amount of each page in step S201, the CPU 111 uses the information. When the CPU 111 determines that the feature amount is changed between the present page and the next page as a result of the processing of step S208 (YES in step S208), the processing proceeds to step S209. In step S209, the CPU 111 stops the scroll display in displaying the preview image of the next page determined that the feature amount is changed. When the preview images for a plurality of pages can be displayed on the preview display area 102, the CPU 111 stops the scroll display in a state where the preview image of the next page determined that the feature amount is changed comes to the center of the display area or in a state where the preview image comes to the right end or the left end.

On the other hand, when the CPU 111 does not determine that the feature amount is changed between the present page and the next page as a result of the processing of step S208 (NO in step S208), the processing proceeds to S210. In step S210, the CPU 111 determines whether the scroll display is ended. The CPU 111 decides a scrolling amount of the scroll display by the flick operation according to the strength of the flick operation, i.e., the moving amount or speed of the finger or pen in the flick operation. In step S210, the CPU 111 determines whether the moving amount by the scroll display reaches the scrolling amount. When the CPU 111 determines the moving amount does not reach the scrolling amount, the processing returns to step S207, and the CPU 111 displays the preview image of the next page on the display 119. On the other hand, when the CPU 111 determines the moving amount reaches the scrolling amount, the processing proceeds to step S209 and the CPU 111 stops the scroll display.

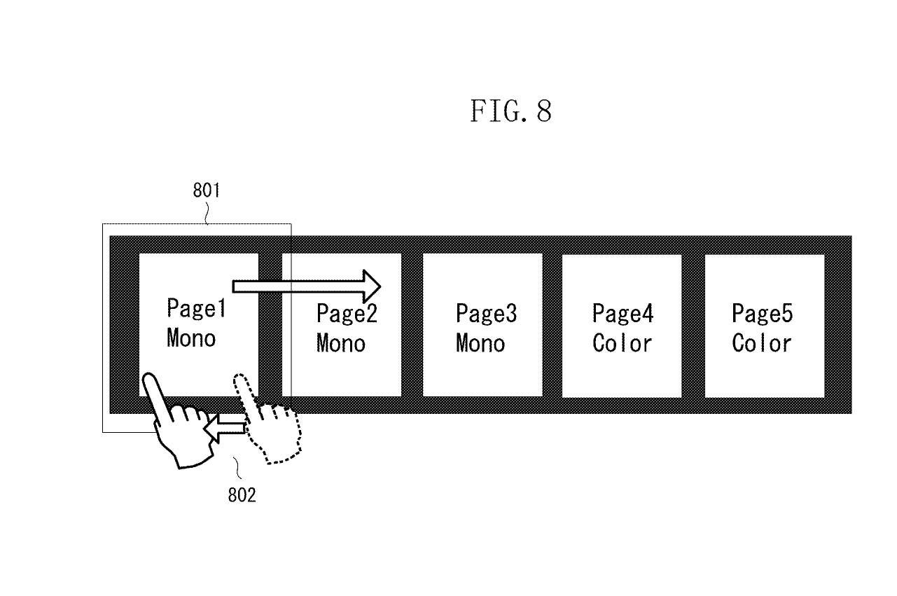

FIG. 8 illustrates an example of a configuration of image data to be preview-display target. FIG. 8 describes display when the scroll display is performed by the flick operation in the case where the image data is preview-displayed.

The example of FIG. 8 is image data including five pages. The first to third pages are data of monochrome images. The fourth and fifth pages are data of color images. Therefore, the image data of each of the first to third pages has the feature amount of the “monochrome image”. The image data of each of the fourth and fifth page has a feature amount of the “color image”. A frame 801 illustrates the preview display area 102 on a preview display screen. Now, when the user performs a flick operation 802 to a left direction in a state where the first page is displayed on the preview display area 102, the user performs the scroll display, and displays the preview image in order of the second page and the third page according to the strength of the flick operation. In the present exemplary embodiment, in step S208, the CPU 111 determines the change in the feature amount between the pages in displaying the next page by the scroll in order of the second page, the third page, and the fourth page.

When the scroll display is performed from page 1 to page 2 and from page 2 to page 3 in the example of FIG. 8, the feature amount is the “monochrome image” and is not changed between the pages. However, when the scroll is performed from the page 3 to page 4, the feature amount is changed to the “color image” from the “monochrome image”. Therefore, even if the strength of the flick operation is a strength which can be scrolled to the fifth page in the present exemplary embodiment, the scroll is stopped when the preview image of the fourth page from which the change in the feature amount is detected is displayed. Thereby, the user easily confirms the page in which the image data is changed.

Referring back to FIG. 7, the description will be continued. When the operation received in step S204 is an operation for instructing the movement of the display position of the preview image, the processing proceeds to step S212. The operation is any of the push of the display area moving button 105 and the drag operation to the preview image. In step S212, the CPU 111 changes the display position of the preview image. Then, the processing returns to step S204.

When the operation received in step S204 is instruction for closing the preview screen 100, the processing proceeds to step S213. The operation is the push of the close button 107. In step S213, the CPU 111 closes the preview screen 100 displayed at present, and displays another arbitrary screen on the display 119.

Thus, the CPU 111 performs control so that the scroll is stopped at a timing when the feature amount of the image between the pages is changed in the scroll display in the preview display of the present exemplary embodiment. This can prevent a problem that the user hardly confirms the content of the feature amount of the image according to the scroll display although the feature amount of the image is changed between the pages. That is, the user can certainly confirm the page in which the feature amount is changed between the pages.

A modification will be described. In the description of the exemplary embodiment, the feature amount of the image of the present page is merely compared with that of the next page. When the feature amount is changed, the scroll is stopped in the preview display of the next page. However, apart from this, various modifications are considered.

For example, when a plurality of feature amounts are changed between the pages, the CPU 111 may decide whether the scroll is stopped based on whether the feature amount equal to a certain threshold vale or greater is changed. The CPU 111 may extract the plurality of feature amounts in the image data for every page. A case where the feature amount of the image of the first page is “monochrome image”, “output paper size A4”, and “character data”, and the feature amount of the image of the second page is “color image”, “output paper size A4”, and “photograph image” is considered as a specific example. At this time, the number of the changed feature amounts is two among the respective three feature amounts included in each of the first page and the second page. If the threshold value which is a condition where the scroll is stopped is equal to or less than “two”, the scroll is stopped in the preview display of the second page.

On the other hand, when the threshold value which is the condition where the scroll is stopped is equal to or greater than “three”, the scroll is not stopped even in the preview display of the second page. In this way, even when the image data of the plurality of pages in which the plurality of feature amounts may be changed are scroll-displayed, the scroll is not frequently stopped, which does not reduce operability actually. The user may arbitrarily set the threshold value which is the condition for stopping the scroll in the present exemplary embodiment.

As the other example, a feature amount to be employed as the condition for stopping the scroll and a feature amount not to be employed as the condition may be previously decided. For example, the feature amount illustrating the color image or the monochrome image is employed as the condition for stopping the scroll. The information of the output paper size is not employed as the condition for stopping the scroll. If the above conditions are decided in the case of the specific example, whether the color image or the monochrome image is the feature amount to be employed as the stopping condition in the first page and the second page. The future amount is changed, so that the scroll is stopped. Supposedly, if the feature amount illustrating whether the color image or the monochrome image is not employed as the condition for stopping the scroll, and the information of the output paper size is employed as the condition for stopping the scroll, the scroll is not stopped in the case of the specific example. Even in this case, the user may arbitrarily set the kind of the feature amount employed as the condition for stopping the scroll.

Thus, when the kind of the feature amount employed as the condition for stopping the scroll is decided, the user may perform the selection, and may decide which feature amount is to be used based on the classification of a job to be executed and the setting of the job. Examples of the kind of the job include a copy job, a print job, a sending job, and a FAX job.

More specifically, for example, in the case of the preview display (preview before printing) if the print job is executed, a certain kind of feature amount (for example, the color image or the monochrome image) is employed as the condition for stopping the scroll. In the case of the preview display (preview before sending) if the sending job for sending the scanned data to the outside is executed, another kind of feature amount (for example, whether the orientations of the top and bottom of the image are inverted) is employed as the condition for stopping the scroll. Thus, the user can more certainly confirm the image to be confirmed according to the kind of the job and the setting.

The user stores a page in which any setting is changed in the preview display. When the page is displayed by the scroll again, the user may stop the scroll in the page.

In the example of FIG. 7, the change in the feature amount between the pages is determined only when the scroll is performed by the flick operation. The change is not determined in the case of the scroll performed by pushing the page scroll button 103. In place of the example of FIG. 7, even in the case of the scroll performed by the flick operation, the determination of step S208 and the stop of the scroll by the result may be performed only when the scroll is performed at equal to or greater than certain speed. In this case, the CPU 111 performs processing for determining a scroll speed (or the strength of the flick) after the processing of step S207, and then switches whether the processing proceeds to the processing of step S208 according to the result.

A place where the feature amount between the pages is changed may be highlighted in addition to the stop of the scroll or in place of the stop of the scroll. The highlight means that a line or a character are thickened or enlarged, for example, or a color thereof is changed. The line or the character is displayed so that the user recognizes that the feature amount of the preview image of the page is different from that of the other page. Furthermore, the highlight may be performed by displaying the frame of the preview image of the page in which the feature amount is changed so that the frame is different from that of another preview image.

If the previously decided specific page is preview-displayed in addition to, or in place of stopping the scroll on condition of the change in the feature amount between the pages, control may be performed to certainly stop the scroll. In other words, processing for determining whether the page is the specific page is performed in place of, or in addition to step S208. This is useful in the following situation, for example.

It is assumed that a plurality of storage areas referred to as a box (box No. 1, box No. 2, . . . box No. N) allocated for storing an image exist in the external memory 120. It is assumed that a certain box (box No. 1) is used for exclusive use to store a material of a certain conference. It is assumed that a plurality of materials of conferences is stored in the box; the materials certainly include a cover and contents till a predetermined page; and the materials include different contents from the X^{th} page. In the case, when the user preview-displays the material of the conference stored in the box on the display of the MFP 101 and confirms the content, the user is considered to particularly desire to confirm the contents after the X^{th} page.

Then, if the scroll in the preview display is controlled to certainly stop the scroll at the X^{th} page, user's convenience is improved. The number of pages employed as the condition for stopping the scroll for every box may be previously set in consideration of the case of the example. The stop by the change in the feature amount may be used together. For example, “the fifth page” or the “color/monochrome image” is set as a stop condition when the image data stored in the box No. 1 is previewed, and “the third page” or “when top and bottom are inverted” is set for the box No. 2.

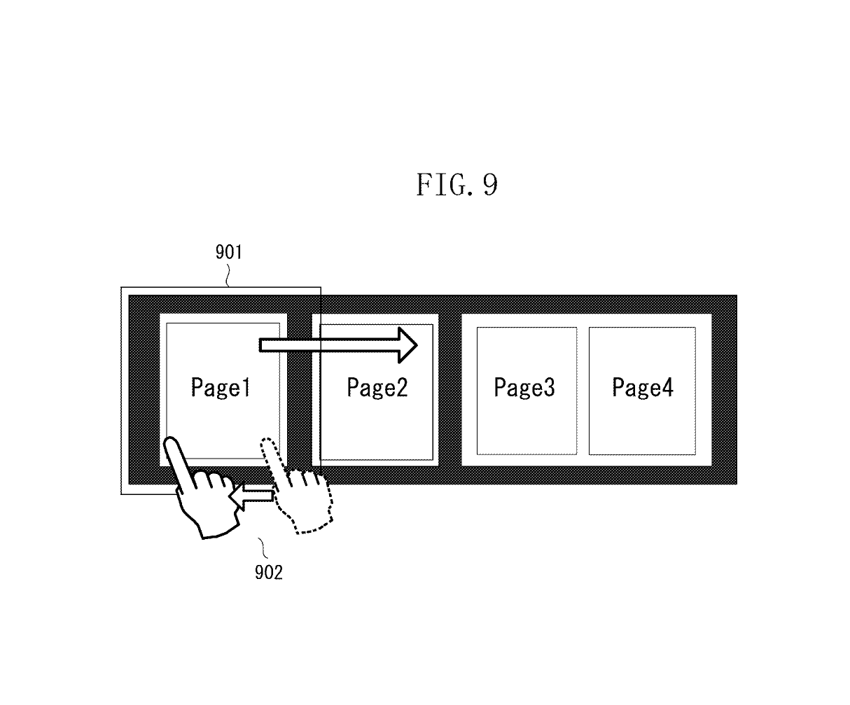

As described above, the change in the print setting between the pages can be also used as the feature amount. FIG. 9 illustrates an example when the image data including a plurality of pages in which the print setting is different between the pages is preview-displayed. In the example of FIG. 9, 1in1 layout is set in the first page and the second page, and 2in1 layout is set in the third page and the fourth page for a document image including four pages. A frame 901 illustrates the preview display area 102 on the preview display screen.

Now, when the user performs a flick operation 902 to a left direction in a state where the first page is displayed on the preview display area, the scroll display is performed to display the preview image in order of the second page and the third page according to the strength of the flick operation. If the three and fourth pages are displayed from the second page at this time, the change in the feature amount between the pages is detected. As a result, even if the strength of the flick operation is a strength which can scroll the page to the fourth page, the scroll is stopped when the preview image of the third page in which the change in the feature amount (in this case, the print setting) is detected is displayed. Thereby, the user easily confirms the page in which the print setting is changed.

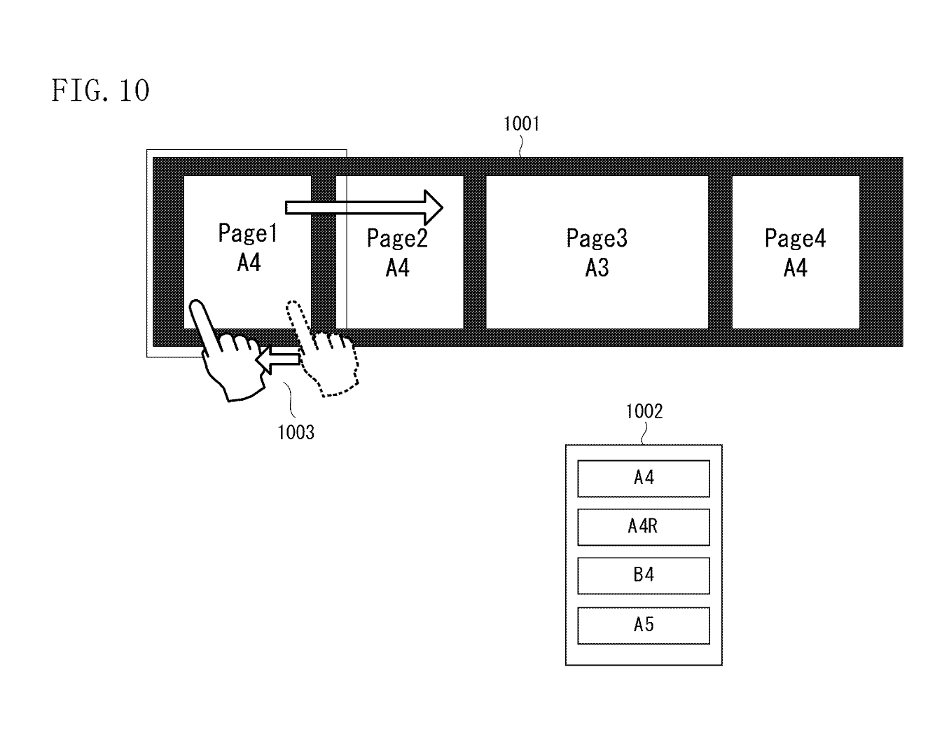

Further, as the condition for stopping the scroll, if a page in which the MFP 101 cannot perform print processing at present exists, the scroll may be controlled to stop the scroll at the page. The print processing cannot be performed at present because reasons such as no paper having a specified size, no color toner, and an unusable post-processing apparatus (for example, a staple or a punch) are considered. FIG. 10 illustrates an example for describing the case. FIG. 10 illustrates image data 1001 to be preview-displayed at present. The image data 1001 includes page 1 to page 4. As illustrated in FIG. 10, the output paper size A4 is set for the page 1, the page 2, and the page 4. The output paper size A3 is set for the page 3.

1002 in FIG. 10 illustrates information of a paper size set in a paper feeding unit included in the MFP 101 at present. It is found that papers A4, A4R, B4, and A5 are respectively set in four paper feeding units in the MFP 101 at present according to the 1002. Therefore, the MFP 101 is in a state where printing using the paper having the size of A3 cannot be performed at present. At this time, when the user performs a flick operation 1003 to a left direction, the scroll display is performed, and the preview image is displayed in order of the second page and the third page according to the strength of the flick operation. At this time, when the scroll is performed from the second page to the third page, the change in the feature amount is detected. The change in the feature amount in this case means that “printable setting” is changed to “unprintable setting”. As a result, even if the strength of the flick operation is a strength which can scroll the page to the fourth page, the scroll is stopped when the preview image of the third page in which the change in the feature amount (in this case, printable or unprintable) is detected is displayed. Thereby, the user easily confirms the unprintable page.

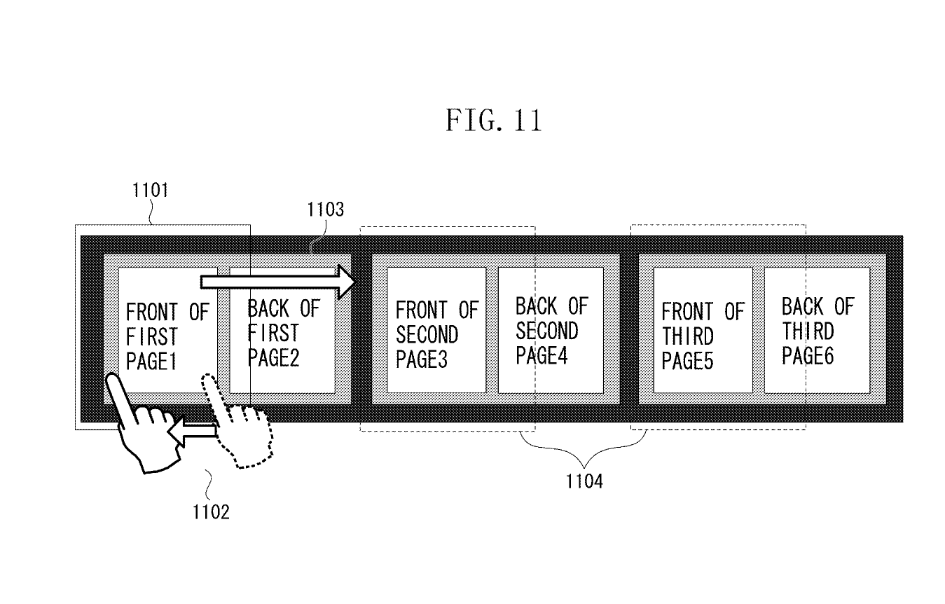

When the preview image is displayed, N images layouted on one page, or two images respectively layouted on the back and front of one page may be separately displayed for the page in which Nin1 layout or both side printing is set. In that case, the separately displayed images are displayed in a manner such that which images are to be collected and printed on one paper during actual printing can be recognized. FIG. 11 illustrates an example of preview display when both side printing is set for an image of a document including six pages.

1101 of FIG. 11 corresponds to the preview display area 102. As illustrated in FIG. 11, when both side printing of document images of six pages is performed, in fact, each image is printed on the back and front of each of print papers for three pages. The present exemplary embodiment displays a frame 1103 representing which pages of document images are collected on one print paper during actual printing, which can be confirmed by the user. If a flick operation 1102 is performed in that case, processing is performed as follows. Specifically, the feature amounts for each of the images of the pages 1 to 6 corresponding to the document images are not compared. The document images collected during printing are grouped, and the change in the feature amount is determined in a unit of the group.

The example of FIG. 11 determines the change in the feature amount of each of a first group obtained by collecting the page 1 and the page 2, a second group obtained by collecting the page 3 and the page 4, and a third group obtained by collecting the page 5 and the page 6. If the change corresponds to the condition of the scroll stop to stop the scroll, the scroll is controlled to stop the scroll at the position of a head of each group (for example, 1104 of FIG. 11). Thereby, the user can confirm the images collected to one paper in the group during actual printing.

The scroll is stopped according to each condition in the description of the exemplary embodiment. However, the scroll may be controlled so that the scroll speed is reduced (slowed down) without being limited to the stop of the scroll. Conversely, by increasing the scroll speed as long as the future amount does not match the condition, the scroll speed of a page matching the condition may be relatively reduced. In other words, the scroll speeds of the page matching the condition and a page other than the page matching the condition are changed, and thereby the user may be allowed to easily confirm the page required to prompt the user to confirm.

A second exemplary embodiment will be described. The first exemplary embodiment determines whether the feature amount is changed in the image of the page preview-displayed at present and the image of the page to be displayed next, and stops the scroll when the feature amount is changed. Thereby, the user easily confirms the page in which the feature amount is changed. However, when the pages in which the feature amount is changed are continued, or the feature amount is changed on all the pages, the method frequently stops the scroll, which may spoil user's operability actually. The present exemplary embodiment directs attention to the problem, and describes a mechanism which can more certainly confirm the image to be confirmed by the user without spoiling the user's operability.

Since the display contents of an apparatus or a display conducting the present exemplary embodiment are the same as those of the first exemplary embodiment (FIGS. 1 and 2), the description thereof is omitted. Hereinafter, a difference between the present exemplary embodiment and the first exemplary embodiment will be described in detail.

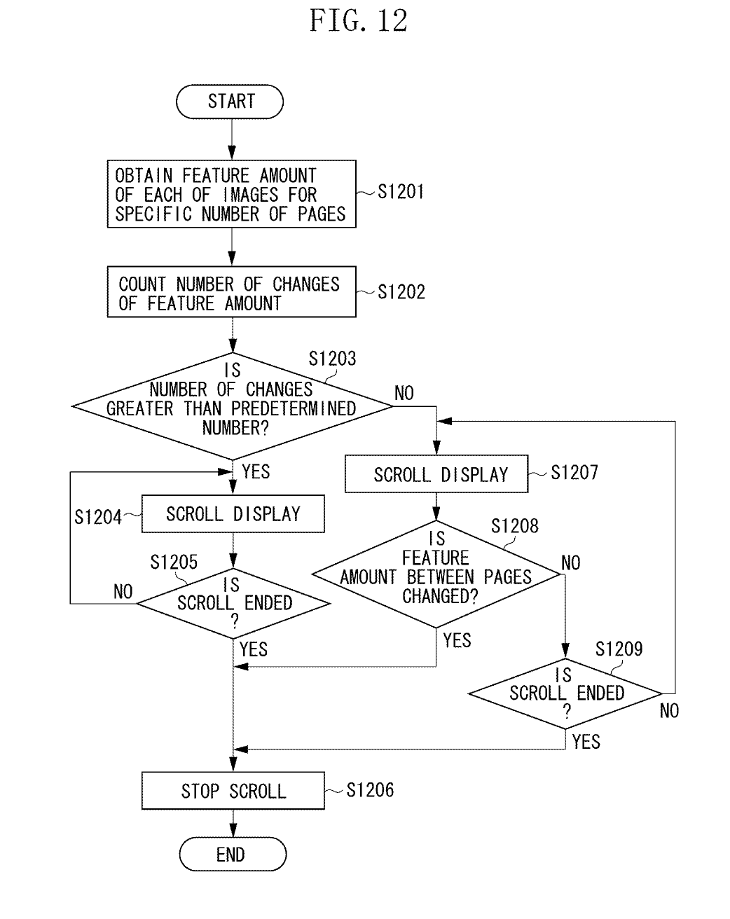

FIG. 12 is a flow chart illustrating an operation of an MFP 101 in the present exemplary embodiment. The flow chart is executed in place of the processings of steps S207 to S210 of FIG. 7. Since the other processings are the same as those of FIGS. 6 and 7, the description thereof is omitted in the present exemplary embodiment. FIG. 12 illustrates processing executed by the MFP 101 when page scroll is instructed by a flick operation to a preview image. A CPU 111 of the MFP 101 executes programs to process each step of FIG. 12. The programs are stored in a memory such as a ROM 113 or an external memory 120. The programs are developed in the RAM 112 and executed.

In step S1201, the CPU 111 obtains a feature amount of each of images for specific number of pages. Since the feature amount of the image of each page is previously stored in the external memory 120, the CPU 111 obtains the feature amounts for the specific number of pages from the external memory 120 in step S1201. Herein, the specific number of pages may be previously determined in the apparatus, or may be arbitrarily set by the user.

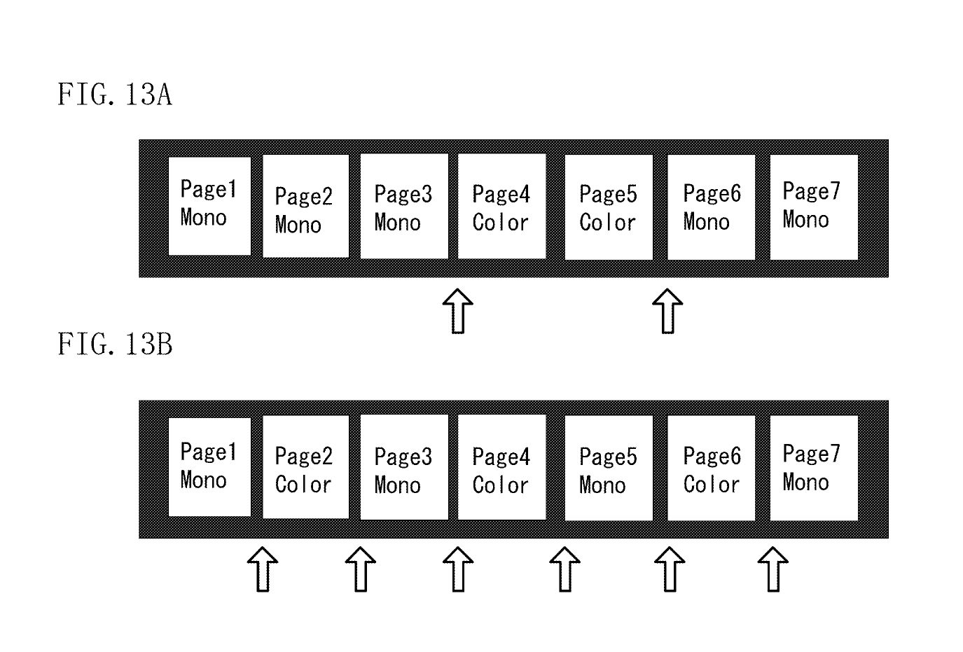

In step S1202, the CPU 111 compares the obtained feature amounts to count how many times the change in the feature amount between the pages occurs in the specific number of pages. FIGS. 13A and 13B respectively illustrate image data including seven pages. The image of each page has information representing a color image or a monochrome image as the feature amount. When the specific number of pages which is a reference in step S1201 is “six pages” as an example, the number of times of change counted in step S1202 is “two” in the case of FIG. 13A. On the other hand, in the case of FIG. 13B, the number of times of change counted in step S1202 is “five”.

Next, in step S1203, the CPU 111 determines whether the number of times of change counted in step S1202 is greater than the predetermined number which is a previously decided threshold value. The predetermined number herein may be previously set for the apparatus, or may be arbitrarily set by the user. The different predetermined numbers may be set according to the kind of a job to be executed and the kind of the feature amount to be employed as a condition of scroll stop.

When the CPU 111 determines that the number of times of change is greater than the predetermined number as a result of the determination of step S1203 (YES in step S 1203), the processing proceeds to step S1204. In step S1204, the CPU 111 performs a scroll display. Then, in step S1205, the CPU 111 determines whether a scroll end point decided by the strength of the flick operation is reached. The CPU 111 repeats processings of steps S1204 and S1205 until the scroll endpoint is reached. On the other hand, if the CPU 111 determines that the scroll end point is reached, the processing proceeds to step S1206 to stop the scroll. Thus, if the CPU 111 determines that the number of times of change is greater than the predetermined number, the scroll is not stopped by the change in the feature amount as described in the first exemplary embodiment.

When the CPU 111 determines that the number of times of change is less than the predetermined number as a result of the determination of step S1203, the processing proceeds to step S1207. In step S1207, the CPU 111 performs the scroll display.

Then, in step S1208, the CPU 111 compares a feature amount of a page in which the preview image is displayed at present with a feature amount of a page to be displayed next in displaying the next page on a display 119 by the scroll display. Since the CPU 111 previously analyzes and holds the feature amount of each page, the CPU 111 uses the information. If the CPU 111 determines that the feature amount is changed between the present page and the next page as a result of the processing of step S1208, the processing proceeds to step S1206. In step S1206, the CPU 111 stops the scroll display at the point of time when the preview image of the next page determined that the feature amount is changed is displayed. If the preview images for a plurality of pages can be displayed on a preview display area 102, the CPU 111 stops the scroll display in a state where the preview image of the next page determined that the feature amount is changed comes to the center of the display area or in a state where the preview image comes to the right end or the left end.

On the other hand, if the CPU 111 does not determine that the feature amount is changed between the present page and the next page as a result of the processing of step S1208 (NO in step S1208), the processing proceeds to step S1209. In step S1209, the CPU 111 determines whether the scroll display is ended. In other words, the CPU 111 determines whether the scroll end point decided by strength of the flick operation is reached. If the CPU 111 determines the scroll end point is not reached (NO in step S1209), the processing returns to step S1207. The CPU 111 displays the preview image of the next page on the display 119. On the other hand, if the CPU 111 determines the scrolling amount is reached (YES in step S1209), the processing proceeds to step S1206, and the CPU 111 stops the scroll display. Thus, if the CPU 111 determines that the number of times of change is less than the predetermined number, the CPU 111 stops the scroll according to the change in the feature amount as described in the first exemplary embodiment.

The processing will be described with reference to a specific example of FIG. 13. If the specific number of pages which is a reference in step S1201 is “six pages”, for example, as described above, the number of times of change counted in step S1202 is “two” in the case of FIG. 13A. On the other hand, in the case of FIG. 13B, the number of times of change counted in step S1202 is “five”. If the predetermined number which is a reference in step S1203 is “four”, the scroll of the preview display of FIG. 13A is stopped if the scroll reaches the fourth page. If the scroll by the flick operation is then further performed, the scroll is stopped if the scroll reaches the sixth page. On the other hand, even if the scroll reaches the second page or the third page, the preview display of FIG. 13B is not stopped.

Thus, if feature changing points exist equal to or greater than the predetermined number in a range in the case of FIG. 13B, the change is disregarded, and the scroll is not stopped. This can prevent a problem that the scroll is frequently stopped to reduce the user's operability actually.

A modification will be described. In the description of the above exemplary embodiment, the CPU 111 counts the number of times of change in the predetermined range, and switches whether the scroll stop is performed based on whether the number exceeds the threshold value. However, apart from this, various modifications are considered.

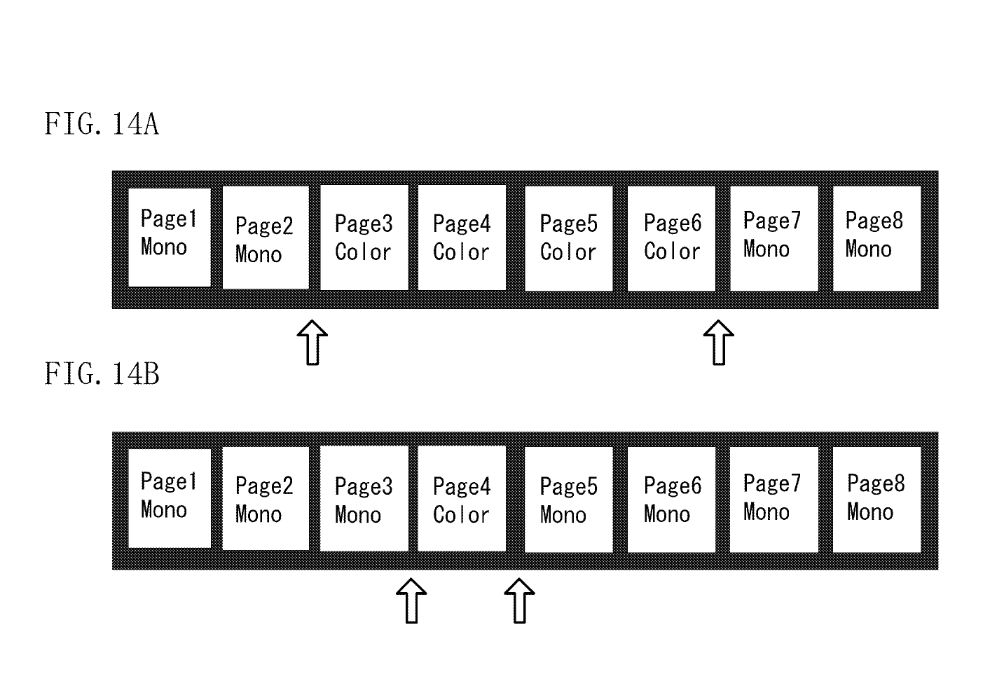

For example, the feature amount of each of a plurality of pages in the predetermined range is analyzed, and only if the feature amount has deviation exceeding a predetermined rate, the scroll may be stopped. The modification will be described with reference to a specific example of FIG. 14.

FIG. 14A illustrates image data including eight pages. Pages 1, 2, 7, and 8 have information representing a monochrome image as the feature amount. Pages 3, 4, 5, and 6 have information representing a color image as the feature amount. Similarly, FIG. 14B illustrates image data including eight pages. Only the page 4 is color image, and the other pages are monochrome images.

In the present exemplary embodiment, the rate of the page for every feature amount in the predetermined range (herein, for eight pages) is calculated. In FIG. 14A, the rate of the page of the monochrome image is four pages/eight pages=50%, and the rate of the page of the color image is four pages/eight pages=50%. On the other hand, in FIG. 14B, the rate of the page of the monochrome image is seven pages/eight pages=87.5% (round off to the closest whole number), and the rate of the page of the color image is one page/eight pages=12.5%. Only if a page including a feature amount of a rate less than a rate (for example, 30%) which is a threshold value exists in the present exemplary embodiment, the scroll is stopped. As a result, in the case of FIG. 14A, the scroll is not stopped even in the third page and the seventh page in which the feature amount is changed.

On the other hand, in the case of FIG. 14B, the scroll is stopped in the fourth page and the fifth page in which the feature amount is changed (herein, only if the page of the feature amount of a small rate is displayed, the scroll may be stopped (only the fourth page)). Since the number of times of change in FIG. 14A and the number of times of change in FIG. 14B are the same (“two”) according to the processing of the flow chart of FIG. 12, scroll control in FIG. 14A should be the same as that in FIG. 14B. However, when the scroll is controlled in the present modification, the scroll can be stopped at the change point of the feature amount in only the case illustrated in FIG. 14B. As a result, in pages in a certain range, if the number of pages having a feature amount different from that of the other page is very few, the user can certainly confirm the pages.

In addition, the present exemplary embodiment enables various modifications such as processing when a plurality of feature amounts are analyzed, as in that described in the modification of the first exemplary embodiment.

However, the scroll may be controlled so that the scroll speed is reduced (slowed down) without being limited to the stop of the scroll as in the first exemplary embodiment (alternatively, the scroll speed is increased). In other words, the scroll speed may be changed in the page matching the condition and the page not matching the condition.

The other embodiment will be described. One apparatus can be also configured by combining the first exemplary embodiment and the second embodiment. In that case, the apparatus includes the operation described in the first exemplary embodiment and the operation described in the second embodiment as the operation mode. The apparatus may automatically switch the operations according to an arbitrary condition. Alternatively, the operation may be manually switched according to user's instruction.

In the description of the exemplary embodiment, the image displayed on the display unit including the touch panel is the preview image. However, the image to be processed in the present invention is not limited to the preview image. The present invention can be applied when not only the preview image but also a plurality of pages in which the feature amount of the image of each page may be different are displayed.

The MFP is used as an example of the apparatus conducting the present invention in the description of the exemplary embodiment. However, the apparatus conducting the present invention is not limited to the MFP. Specifically, the present invention can be applied to not only the MFP but also an image processing apparatus including an image forming apparatus such as a printer, a scanner, a FAX, or a digital camera, and an information processing apparatus such as a PC or a hand-held terminal, and configured to process at least image data.

In the description of the exemplary embodiment, the flick operation is described as the example of the operation performed by the user to perform the scroll display. However, the present invention can be realized without being limited to the flick operation as the user's operation for performing the scroll display. For example, as long as the scroll display is performed by the operation other than flick to the touch panel, the present invention may be conducted in the case. In other words, if the displayed image is scroll-displayed by the predetermined operation by the user, the present invention can be conducted. The predetermined operation herein may be the other gesture operation performed by touching the touch panel, or a gesture operation (a space gesture operation) performed without touching the touch panel besides the flick operation to the touch panel. The image may be projected on a screen using an image projection apparatus such as a projector without limiting the display of the image to be scroll-displayed, to the display of the image on the display unit including the touch panel. The projected image may be scroll-displayed by performing the predetermined gesture operation (space gesture) to the image.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-026159 filed Feb. 9, 2012, which is hereby incorporated by reference herein in its entirety.

What is claimed is:

1. An image processing apparatus comprising:
a display control unit to display image data including a plurality of pages;
a scroll display unit to scroll-display the image data in response to a predetermined operation by a user to the image data displayed by the display control unit;
an obtaining unit to obtain a feature amount representing a feature of each image among the plurality of pages; and
a control unit, in a case where a predetermined page having a feature amount satisfying a predetermined condition is displayed by the scroll display unit, to stop the scroll display.

2. The image processing apparatus according to claim 1, further comprising a determination unit to determine whether a feature amount of an image of a page displayed by the display control unit among the plurality of pages is different from a feature amount of an image of a page next to the page,
wherein the predetermined page is the page that is determined by the determination unit that the feature amount is different.

3. The image processing apparatus according to claim 1, further comprising:
an analysis unit to analyze the feature amount representing the feature of the image for each of the plurality of pages; and
a storage unit to store the feature amount of the image of each page analyzed by the analysis unit,
wherein the obtaining unit obtains the feature amount stored in the storage unit.

4. The image processing apparatus according to claim 1, wherein the image data displayed by the display control unit is a preview image for causing the user to confirm the image before executing processing.

5. The image processing apparatus according to claim 1, wherein the feature amount is at least any of information representing whether the image is a color image, information representing an orientation of the image, and information representing a size of the image.

6. The image processing apparatus according to claim 1, wherein the image processing apparatus is an image forming apparatus to execute print processing, and the feature amount is a setting value of print setting for the print processing.

7. The image processing apparatus according to claim 1, wherein the display control unit displays the image data on a display unit including a touch panel, and the predetermined operation is a flick operation performed to the touch panel.

8. An image processing apparatus comprising:
a display control unit to display image data including a plurality of pages;
a scroll display unit to scroll-display the image data in response to a predetermined operation by a user to the image data displayed by the display control unit;
an obtaining unit to obtain a feature amount representing a feature of each image among the plurality of pages; and
a control unit to perform control so that a scroll display speed is different between in a case where the scroll display unit displays a predetermined page having a feature amount satisfying a predetermined condition and in a case where the scroll display unit displays a page other than the predetermined page.

9. A method for controlling an image processing apparatus, method comprising:
displaying image data including a plurality of pages;
scroll-displaying the image data in response to a predetermined operation by a user to the image data displayed by the displaying;
obtaining a feature amount representing a feature of each image among the plurality of pages; and
performing control, in a case where the predetermined page having a feature amount satisfying a predetermined condition is displayed by the scroll-displaying, to stop the scroll display.

10. A storage medium storing a program for causing a computer to execute each step of the controlling method according to claim 9.
